(19) United States
(12) Patent Application Publication
(10) Pub. No.: US 2026/0349252 A1
(43) Pub. Date: Nov. 5, 2026

(54) OPTICAL LENS FOR AN AUGMENTED REALITY DISPLAY

(71) Applicant: Alpha Lum SA, Lausanne (CH)

(72) Inventor: Eric Tremblay, Lausanne (CH)

(21) Appl. No.: 19/115,691

(22) PCT Filed: Sep. 26, 2023
(86) PCT No.: PCT/EP2023/076492

§ 371 Date: Mar. 26, 2025

(30) Foreign Application Priority Data
Oct. 13, 2022 (DE) 10 2022 126 674.5

(51) Int. Cl. G02B 27/01; G02B 17/08; G02B 27/00; G02B 27/28

(52) U.S. Cl. CPC G02B 27/0172; G02B 17/0856; G02B 27/0081; G02B 27/283; G02B 27/286; G02B 2027/0105; G02B 2027/0178

(57) ABSTRACT

In an embodiment an optical lens includes an optical spreader and an optical combiner having a first side and a second side opposite to the first side, wherein the optical combiner is configured to transmit ambient light incident on the first side and to collimate image light incident on the second side, wherein the optical spreader is configured to spread the collimated image light so as to form spread image light, wherein the optical spreader includes a hologram and the optical combiner includes a polarizer, wherein the hologram and/or the polarizer have a curved profile, wherein the optical combiner includes an optically-powered reflector, wherein the polarizer and the optically-powered reflector define an optical cavity, and wherein a retarder is located in the optical cavity.

### CROSS-REFERENCE TO RELATED APPLICATIONS

This patent application is a national phase filing under section 371 of PCT/EP2023/076492, filed Sep. 26, 2023, which claims the priority of German patent application no. 102022126674.5, filed Oct. 13, 2022, each of which is incorporated herein by reference in its entirety.

### TECHNICAL FIELD

This disclosure relates to an optical lens for an augmented reality display, an optical system for an augmented reality display and a wearable augmented reality display.

### BACKGROUND

Off-axis retinal displays are a type of display that are used in virtual and augmented reality, or AR, applications such as in wearable head-up displays. Such displays are designed to allow a user to see projected content in his field of view (FOV) whilst viewing an external environment. The displays work by using a projector secured to a user's head to project an image onto the retina of the user which causes the user to see displayed content floating in space in front of them.

The projector is attached to the side of (i.e. off-axis to) a wearable frame, for example a headset or glasses frame with eye pieces. Each eye piece is provided with a holographic combiner which is illuminated by the projector. The illuminated holographic combiners cause the image to be projected through the user's pupil onto their retina.

As is known in the field, in near-eye optical devices such as ORSDs (short for “off-axis retinal scanning displays”), the term “eyebox” refers to a volume of space relative to the ORSD in which the user has to position his eye to be able to correctly see the full, projected image. If an ORSD has a small eyebox, the range of eye positions at which the user can correctly see the full image is small. If an ORSD has a large eyebox, the range of eye positions at which the user can correctly see the full image is greater which thus provides a better user experience. If the user moves his eye position outside of the eyebox, he will see only part of the projected image or not see it at all. This is because it is only in the eyebox that the user's pupil and thus retina is correctly aligned with the optical path of the light projected by the ORSD. It is also known that the gaze direction of a user can effect whether or not the user's pupil lines up with the optical path of the light projected by the ORSD, particularly where the eyebox is small and only covers the eye position of a user gazing directly ahead.

Recently, a design for optical lenses for an augmented reality display, e.g. reflective pancake lenses, have been developed that allows to replicate an exit pupil of the image generator at a plurality of positions in a plane at the eye of the user or so as to form an expanded version of an exit pupil of the image generator in a plane at the eye of the user to thereby expand an eyebox of the optical system to a size which is large enough to be practical whilst also reducing the physical thickness of an eyepiece which includes the optical lens, thereby resulting in a more compact eyepiece and a more compact optical system for an AR display (AR short for “augmented reality”).

The design for optical lenses suggests composing optical lenses of an optically powered reflector plus a planar hologram/polarization reflector. The configuration delivers sharp on-axis performance but large field curvature. This means that the user needs to accommodate his focus to bring off-axis field points into focus. While accommodation is often allowable in visual instruments (e.g. telescopes), it may present problems with divergence accommodation conflict in a binocular near eye display. For this reason it is desirable to find optical designs for the reflective pancake that have improved resolution over field without the need for accommodation.

### SUMMARY

Embodiments provide an optical lens and an optical system for an augmented reality display, as well as a wearable augmented reality display, which features improved resolution over the optical field without the need for accommodation of the user.

The following relates to an improved concept in the field of optical lens design, e.g. for an augmented reality display. One embodiment relates to allow curvature of one or more optical components of the optical lens. For example, hologram material and/or polarizer may have a curved profile. In doing so the improved concept offers degrees of freedom to the optical design that allows us to improve the optical performance of a display path (e.g. modulation transfer function, MTF, over field). To add degrees of freedom, an optical element, e.g. closest to the eye, can be curved. For example, a hologram and a reflective polarizer can be arranged in this element, which opens a number of design choices: keep one of the two flat (e.g., buried within the optical element) or curve both. For example, a larger curvature may be allowed to reach improved performance (e.g. in the display light path).

In at least one embodiment, an optical lens for an augmented reality display comprises an optical spreader and an optical combiner. The optical combiner has a first side and a second side opposite to the first side. The optical spreader comprises a hologram and the optical combiner comprises a polarizer. The hologram and/or the polarizer have a curved profile.

The optical combiner is operable to transmit ambient light, which is incident on the first side and to collimate image light incident on the second side. The optical spreader is operable to spread collimated image light exiting the optical combiner so as to form spread image light. For example, the optical spreader can be configured to transmit and spread image light in an optical system so as to form spread image light or to reflect and spread image light so as to form spread image light.

Allowing for a curved profile of the hologram and/or the polarizer opens a larger degree of freedom to design the optical lens for its desired purpose, e.g. as a component of an optical system for an augmented reality display. This results in a significant improvement of optical quality, such as off-axis resolution. More specifically, the improved concept allows to use a curved polarizer, or both a curved hologram and polarizer, for example. This adds degrees of freedom to the optical design that allows to improve the optical performance of the display path (e.g. MTF over field). Since the optical lens is often required to be see-through, there are constraints on the optical design, namely, the refractive power should be zero on see-through, with low aberrations (blurring, distortion). To add degrees of freedom, the optical element closest to the eye of the user can be curved. Since the hologram and the reflective polarizer can be arranged in this element there is a choice: keep one of the two flat (buried within the element) or curve both. Furthermore, a larger curvature is allowed to reach improved performance (display light path).

Hereinafter, a curved profile is at least partially convex, concave, cylindrical, spherical or aspherical. The term “profile” refers to the curvature of one or more optical surfaces. In contrast, a linear profile indicates that one or more optical surfaces are flat in the sense that said surface is planar as opposed to a curved profile, which may have one or more convex or concave sections, for example. In general, a curved profile may be described by any mathematical function, e.g. as an aspherical optical surface, which is neither spherical nor cylindrical. The curved profile can be represented by a continuous function. In general, a curved profile may be defined section by section, e.g. with sections being represented by continuous function, respectively. Thus, the optical design may alter the curved profiles individually and by section, thus, offering a further degree of freedom.

The optical spreader can have a number of optical properties. For example, the optical spreader is configured to transmit the ambient light without spreading the ambient light. The optical spreader can be configured to transmit the ambient light essentially without aberration of the ambient light. The optical spreader may comprise an optical fan-out component, an optical beam-expander or an optical diffuser. The optical spreader may have no optical power or be optically-powered.

In at least one embodiment, the optical combiner is configured to transmit the ambient light essentially without aberration of the ambient light. The term “essentially without aberration” relates to no or negligible aberration of ambient light, e.g. when the optical lens is integrated into an optical system. Aberrations may include all common optical distortions, such as blurring, distortion, chromatic aberrations, astigmatism, etc. The term “essentially” also indicates that aberration may be noticeable to some degree, which either does not matter of a desired application or may be accounted for by means of image or video processing.

Despite the constraint of essentially no aberrations, the proposed optical design provides additional degrees of freedom that allow to improve the off-axis optical performance of the display path (e.g. modulation transfer function, MTF, over field).

In at least one embodiment, the total refractive power (see-through) of the optical lens, including the optical spreader and the optical combiner, is zero. For example, in a lens design, wherein only the optical spreader and the optical combiner are present, these optical elements combined may result in total refractive power of zero.

The “see-through” requirement may relate to a use case of the proposed concept, e.g. for an optical system of an augmented reality display, but imparts strong constraints on the optical design, e.g. the refractive power should be zero, or at least close to zero, on see-through, with low aberrations, such as blurring, distortion, etc. Despite these constraints, the proposed optical design provides additional degrees of freedom that allow to improve the off-axis optical performance of the display path (e.g. modulation transfer function, MTF, over field).

In at least one embodiment, the optical combiner is, or comprises, a reflective pancake optical combiner. A reflective pancake provides low profile and, thus, may require less space in an optical system of an augmented reality display.

In at least one embodiment, the hologram is, or comprises, a Volume Phase Hologram, VPH.

For example, the VPH comprises one or more VPH gratings. These gratings are free of, or have no, surface grooves. One or more surfaces of the VPH grating(s) may be curved according to the curved profile, or sections thereof. For VPH gratings diffraction may occur as incoming light crosses through a film with periodic index modulations sealed between consecutive substrates.

For example, the volume phase hologram comprises an active optical structure. Particularly, the impact of the active optical structure of the volume phase hologram on impinging/passing light is only Bragg diffraction.

In at least one embodiment, the optical lens further comprises at least one lens body and the hologram and/or the polarizer are buried inside the lens body and/or are arranged on a surface of the lens body. For example, the hologram and/or the polarizer may comprise a dielectric which can be formed to have optical power and can be buried inside the material forming the lens body.

In at least one embodiment, the optical lens further comprises a number of lenses, each comprising a respective lens body, and the lenses forming a doublet, triplet, or multiplet, and/or a catadioptric system.

For example, one or more optical elements, can be implemented as a mirror. Thus, the overall lens can be considered as a catadioptric system. Furthermore, the optical lens may comprise any number of additional lenses or groups of lenses, thus, forming a multiplet, and/or a catadioptric system.

In at least one embodiment, the optical lens further comprises a first lens and a second lens forming a doublet. The front side of the optical combiner is, or is arranged on, a surface of the first lens. Particularly, the front side of the optical combiner is the first side of the optical combiner. The back side of the optical combiner is, or is arranged on, a surface of the second lens. Particularly, the back side of the optical combiner is the second side of the optical combiner. The hologram and/or the polarizer are buried in the lens body of the second lens or are arranged on a surface of the lens body of the second lens. For example, the hologram and/or the polarizer can be arranged in or on the optical element or lens, which, in use, may be located nearest to the eye of a user.

In at least one embodiment, the polarizer is, or comprises, a polarization-dependent reflector.

In at least one embodiment, the polarizer is configured to only reflect light of a predetermined polarization state. In addition, or alternatively, the polarizer is configured to only reflect light which has a wavelength in one or more narrow spectral bands, each spectral band being arranged around a wavelength of the image light. In addition, or alternatively, the polarizer is configured to only reflect light of a predetermined linear polarization. In addition, or alternatively, the polarizer comprises a polarizing mirror.

In at least one embodiment, the optical combiner comprises an optically-powered reflector and the polarizer and the optically-powered reflector define an optical cavity, wherein a retarder is located in the optical cavity.

In at least one embodiment, the optical combiner comprises an optically-powered reflector, a retarder which comprises, or is configured to act as, a quarter-wave plate, and/or a circular polarizer for circularly polarizing ambient light before the ambient light is incident on the first side of the optical combiner.

For example, the circular polarizer is arranged for circularly polarizing ambient light before the ambient light is incident on the first side of the optical combiner, for example wherein the circular polarizer is disposed on an outer surface of the optically-powered reflector.

In at least one embodiment, the polarizer and the optically-powered reflector define an optical cavity, and wherein the retarder is located in the optical cavity.

For example, the optical cavity comprises air or is air-filled. A solid transparent member or a solid transparent material can be located in the optical cavity. Alternatively, the optical cavity can be filled with a solid transparent material such as a polymer material or a glass material.

In at least one embodiment, the optically-powered reflector comprises at least one of: a curved mirror, a Fresnel reflector, or a diffractive mirror such as a volume phase hologram or a polarization volume grating. The optically-powered reflector is configured to reflect light in one or more narrow spectral bands, each spectral band being arranged around a wavelength of the image light and the optically-powered reflector being configured to have a reflectance in each spectral band of 90% or greater, 95% or greater, or 99% or greater.

For example, the optically-powered reflector comprises an optically-powered dichroic reflector. In addition, or alternatively, the optically-powered reflector comprises a transparent substrate and a dichroic reflective coating disposed on one surface of the transparent substrate. In addition, or alternatively, the optically-powered reflector is configured to partially reflect the image light, for example wherein the optically-powered reflector is configured to reflect 50% of the image light. In addition, or alternatively, the optically-powered reflector comprises an optically-powered partial reflector. In addition, or alternatively, the optically-powered reflector comprises a transparent substrate and a partially reflective coating, such as a half-silvered partially reflecting coating, disposed on one surface of the transparent substrate.

Furthermore, an optical system for an augmented reality display is suggested. The optical system comprises an optical lens according to one or more of the aforementioned embodiments. Furthermore, the optical system comprises an image generator, which is operable to generate the image light.

The optical lens is to be located in a field-of-view of a user of the optical system between the user and a scene. Then, if ambient light from the scene is incident on the first side, said light is transmitted towards an eye of the user. Image light from the image generator is incident on the second side and traverses the optical combiner several times and exits the optical combiner towards the eye of the user as the collimated image light from the second side, whilst the ambient light traverses the optical combiner only once. For example, the image generator is configured to focus the image light to a focal plane and the optical spreader is located at the focal plane.

In at least one embodiment, the optical combiner is configured to reflect, and control the divergence of, the image light so that the image light traverses the optical combiner four times and exits the optical combiner as collimated light from the second side of the optical combiner, whilst the ambient light traverses the optical combiner only once.

Furthermore, a wearable augmented reality display is suggested. The wearable augmented reality display comprises an optical system according to one or more of the aforementioned embodiments. A support frame is arranged for mounting the optical system on a user so that the optical lens is positioned in a field-of-view of a user.

Further embodiments of the wearable augmented reality display become apparent to the skilled reader from the aforementioned embodiments of the optical lens and optical system for an augmented reality display and vice-versa.

### BRIEF DESCRIPTION OF THE DRAWINGS

The following description of figures may further illustrate and explain embodiments of the optical lens and the optical system for an augmented reality display, as well as of the wearable augmented reality display. Components and parts of the optical lens that are functionally identical or have an identical effect are denoted by identical reference symbols. Identical or effectively identical components, parts and steps of the method might be described only with respect to the figures where they occur first. Their description is not necessarily repeated in the description of successive figures.

FIG. 1 shows a schematic illustration of a head-mounted AR display;

FIG. 2 shows an example embodiment of an optical lens for an augmented reality display;

FIG. 3 shows another example embodiment of an optical lens for an augmented reality display;

FIG. 4 shows another example embodiment of an optical lens for an augmented reality display; and

FIG. 5 shows another example embodiment of an optical lens for an augmented reality display.

### DETAILED DESCRIPTION OF ILLUSTRATIVE EMBODIMENTS

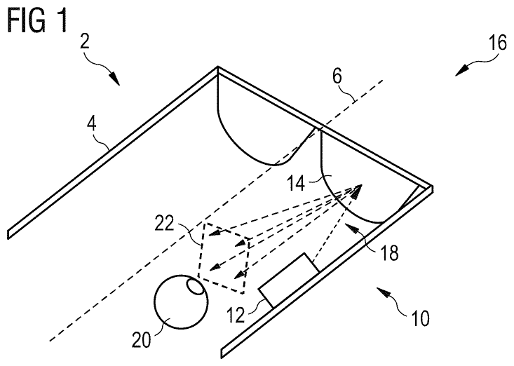

FIG. 1 shows a schematic illustration of a head-mounted AR display 2. The wearable AR display 2 comprises a support frame 4 with a central axis 6 and an optical system 10 in the form of an off-axis retinal scanning display mounted on the support frame 4. The optical system 10 comprises an image generator in the form of a scanning laser projector 12 and an eyepiece 14. The projector 12 is offset from the central axis 6.

In use, when the support frame 4 is mounted on the head of a user with the eyepiece 14 positioned in a field of view of the user, the eyepiece 14 transmits ambient light from a scene 16 located in front of the eyepiece 14 through the eyepiece 14 to an eye 20 of the user located behind the eyepiece 14 and the scanning laser projector 12 projects linearly polarized image light 18 defining an image towards the eye 20 of the user by way of the eyepiece 14. The linearly-polarized image light 18 may include one or more wavelengths such as one or more of red light, green light or blue light.

The eyepiece 14 comprises one or more optical lenses for an augmented reality display, which replicate the image defined by the projected image light 18 a number of times at a plurality of positions in a plane 22 at the eye 20 of the user to expand an eyebox of the wearable AR display 2. Particularly, the plane 22 is a focus plane of the eye of the user. For example, in use the scanning laser projector 12 projects linearly polarized image light 18. The optical system 10 replicates an image defined by linearly-polarized principal rays at different positions in the plane 22 at the eye 20 of the user to provide an expanded eyebox in the plane 22 at the eye 20 of the user for each principal ray of the projected image light 18.

The following discussion discloses a number of example embodiments of optical lenses for augmented reality displays. In order to better describe the optical function, the optical lenses are shown between the eye 20 of the user and the scene 16. The optical lenses at least comprise an optical spreader 59 and an optical combiner 50. Additional optical elements can be present, which will be discussed in further detail below.

The optical combiner 50 has a first side 51 and a second side 52 opposite to the first side 51. In the embodiments discussed below, both the optical spreader 59 and optical combiner 50 are configured to transmit ambient light 32 without, or negligible, aberration of the ambient light 32. In other words, the optical design of the optical lenses has the constraint to be “see-through”, which imparts strong constraints on the optical design, namely the refractive power should be zero, or at least close to zero, on see-through, with low aberrations, such as blurring, distortion, etc. Despite these constraints, the proposed optical design provides additional degrees of freedom that allow to improve the off-axis optical performance of the display path (e.g. modulation transfer function, MTF, over field). While the “see-through” requirement may relate to a use case of the proposed concept, it should in no way be construed as a limitation. In fact, the optical design may allow for some degree of aberration, which, in turn, could be accounted for by means of image or video processing. It is also possible to add optical power to allow for a user's lens prescription (myopia, hyperopia etc.)

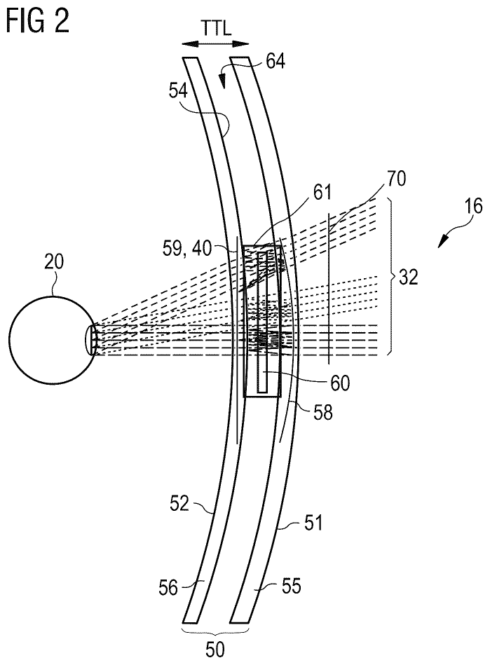

FIG. 2 shows an example embodiment of an optical lens for an augmented reality display. This first design shows an optical lens with a flat hologram 40 and a curved polarization reflector 54. The optical spreader 59 is implemented in the form of a transmissive volume phase hologram (VPH) 40. In the optical system 10 the VPH is operable to fan-out the projected image light 18 to form spread image light. The optical lens further comprises the optical combiner 50 in the form of a “reflective pancake” optical combiner. In the optical system 10 the optical combiner 50 is operable to collimate the spread image light and to reflect the collimated light back through the VPH 40 to form collimated light which propagates to the plane 22 at the eye 20 of the user to provide the expanded eyebox in the plane 22 at the eye 20 of the user.

The VPH 40 can be configured to selectively spread or fan-out light which is incident on the VPH 40 according to an angle of incidence of the light incident on the VPH 40. For example, the VPH 40 can be configured to spread or fan-out the image light 18 incident on the VPH 40 at higher angles of incidence but to transmit the ambient light 32 from a scene 16 without spreading or fanning-out the ambient light 32 from the scene 16.

In this exemplary embodiment, the VPH 40 has a flat or linear profile. The term “profile” refers to the curvature of one or more optical surfaces. A linear profile indicates that the VPH 40 is flat in the sense that it has a planar optical surface as opposed to a curved profile, which has one or more convex or concave optical surfaces, for example. In general, a curved profile may be described by any mathematical function, e.g. as an aspherical optical surface which is neither spherical nor cylindrical.

The optical combiner 50 comprises one or more optical elements. In this embodiment, the optical combiner comprises a first lens 55 and a second lens 56 and, thus, forms an optical objective. The optical combiner 50 has a first side 51 or front side 51, which can be disposed towards the scene 16 and a second side 52 or rear side 52 which can be disposed towards the VPH 40. For example, the front side 51 may be considered to be on a surface of the first lens 55 and the back side 52 may be considered to be on a surface of the second lens 56. The lenses 55, 56 comprise curved transparent bodies or substrate (e.g., glass or transparent polymers such as PMMA or OKP4 polymer for higher index of refraction). The lenses 55, 56 in this embodiment are biconvex lenses, as seen from the scene 16, for example, i.e. have a positive radius of curvature (ROC) towards the user's eye. The two lenses 55, 56 can be monocentric or non-monocentric. The lenses 55, 56 may have a common centre of curvature (or exit pupil).

The first lens 55 is complemented with a dichroic reflector 58. The dichroic reflector 58, is particularly, an optically-powered reflector. In this example embodiment the dichroic reflector 58 comprises a convex dielectric, which is buried in the transparent body of the first lens 55. The dichroic reflector 58 can be configured to be highly reflecting in one or more narrow spectral bands, each narrow spectral band being arranged around a corresponding wavelength of the image light 18, but to transmit light at other wavelengths. The dichroic reflector 58 is, for example, a dichroic reflective reflector. For example, the dichroic reflective reflector 58 may be configured to have a reflectance in each spectral band of 90% or greater, 95% or greater, or 99% or greater. The dichroic reflective reflector 58 can be configured to reflect ambient light 32 at wavelengths inside the one or more narrow spectral bands but to transmit ambient light 32 at wavelengths outside the one or more narrow spectral bands.

The optical combiner 50 further comprises a polarization-dependent reflector 54, or polarizer, which is arranged inside the second lens 56, or on a surface of the second lens 56, for example. The polarizer 54 is curved, i.e. has an optical surface with a curved profile. In this embodiment the curved profile is defined by the curvature of the second lens 56, i.e. is convex.

The optical combiner 50 typically comprises further optical elements, which are not shown for easier representation. For example, a retarder 60, such as a quarter wave plate, is comprised by the optical combiner 50. The retarder 60 can be another separate optical element, or curved and added to or incorporated into the polarization reflector 54.

The polarization-dependent reflector 54 and the dichroic reflector 58 define an optical cavity 61, wherein the retarder 60 is located. Moreover, the polarization-dependent reflector 54 and the dichroic reflector 58 are arranged so that the polarization-dependent reflector 54 is located in an optical path between the VPH 40 and the dichroic reflector 58. The retarder 60 and the dichroic reflector 58 are typically separated by an air gap 64.

The optical lens can be implemented into the optical system 10 of wearable AR display 2 shown in FIG. 1. For example, two such optical lenses for the eyepieces 14 for the augmented reality display are provided. The eyepiece 14 further includes an optional circular polarizer (not shown), which can be disposed on the dichroic reflector 58.

In use, the optical combiner 50 effectively combines the ambient light 32 which is incident on the first side 51 of the optical combiner 50 with the collimated light which exits the second side 52 of the optical combiner 50. For example, a circular polarizer 70 imparts a circular polarization to the ambient light 32 and the circularly-polarized ambient light 32 is incident on the first side 51 of the optical combiner 50 defined by the dichroic reflector 58. The dichroic reflector 58 transmits, towards the retarder 60, the wavelengths of the circularly-polarized ambient light 32 which fall outside of the one or more narrow spectral bands over which the dichroic reflector 58 is highly reflecting. The retarder 60 converts the circularly-polarized ambient light 32 transmitted by the dichroic reflector 58 to linearly-polarized ambient light 32 having a linear polarization which is aligned with a polarization transmission axis of the polarization-dependent reflector 54 so that the polarization-dependent reflector 54 transmits the linearly-polarized ambient light 32 towards the eyebox. Use of the circular polarizer 70 at least partially suppresses the reflection of ambient light 32 from the polarization-dependent reflector 54 thereby at least partially suppressing the formation of any ghost images of the scene 16 at the eyebox.

It has been found that the proposed optical lens may have an improved optical performance relative to prior art lenses, including a larger field of view, a higher resolution and/or a larger eyebox. Furthermore, another embodiment relates to reduced thickness for a required focal length.

An example set of parameters could be as follows. The lenses 55, 56 in this embodiment could be base-6 lenses or dual base-4 lenses, having lens diameters of some 40 mm, and a TTL, such as a distance between the lenses 55, 56, of 7 mm. The first lens 55 may have a thickness of about 2 mm and the second lens 56 of about 1.5 mm. Optical element calculations show that the design shows improved resolution over the optical field, e.g. supports full FOV of 50 degrees with good MTF for various wavelengths over at least 20 degrees without refocus. Barrel distortion can be kept low at about 5.5%. The calculations indicate no significant axial color aberration. Lateral color can be software corrected, if needed. The example set of parameters is for illustration purpose only and leaves room for further improvements. The design may only be limited by parameters defined by the application at hand, e.g. form factor and see-through quality.

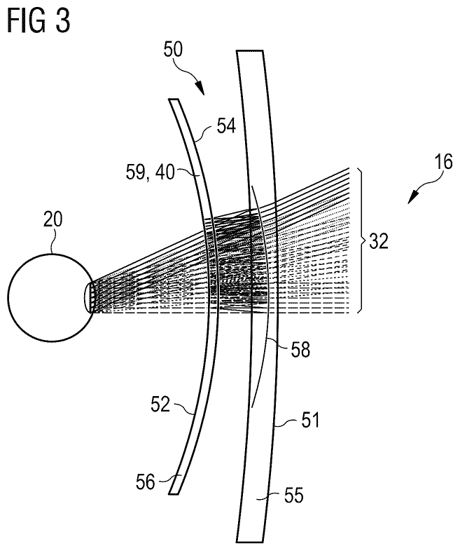

FIG. 3 shows another example embodiment of an optical lens for an augmented reality display. This second design shows an optical lens with a curved hologram 40 and a curved polarization reflector as polarizer 54. As this design builds on the one shown in FIG. 2, only some differences are highlighted.

The optical spreader 59 is implemented in the form of a curved transmissive volume phase hologram (VPH) 40. In the optical system 10 the VPH 40 is operable to fan-out the projected image light 18 to form spread image light. Both, the curved hologram 40 and curved polarization reflector 54 are implemented inside the second lens 56, or on a surface of the second lens 56, for example. The curved hologram 40 and curved polarization reflector 54 are curved, i.e. have an optical surface with a curved profile. In this embodiment the curved profile is defined by the curvature of the second lens 56, i.e. is convex.

The optical lens further comprises the optical combiner 50 in the form of a “reflective pancake” optical combiner. In the optical system 10 the optical combiner 50 is operable to collimate the spread image light 18 and to reflect the collimated light back through the VPH 40 to form collimated light which propagates to the plane 22 at the eye 20 of the user to provide the expanded eyebox in the plane 22 at the eye 20 of the user. In this example, the dichroic reflector 58 comprises a conic aspherical dielectric, which is buried in the transparent body of the first lens 55. The two lenses 55, 56 can be monocentric or non-monocentric.

This lens design shares the improved optical performance relative to prior art lenses, i.e. larger field of view, higher resolution and/or larger eyebox. An example set of parameters could be as follows. The lenses 55, 56 in this embodiment could be base-2.5 lenses having lens diameters of some 40 mm. The first lens 55 may have a thickness of about 2.5 mm and the second lens 56 of about 1.0 mm, and a TTL, such as distance between the lenses 55, 56, of 6.5 mm. Optical element calculations show that the design shows improved resolution over the optical field, e.g. supports full FOV of 30 degrees with excellent performance. Barrel distortion can be kept low at about 7% over 50 degrees. The optical lens features a mass equivalent to 3.5 mm thick lens. The design includes only spherical surfaces except the buried dichroic reflector 58, which is conic aspherical. The optical properties include good see-through, low distortion, aberrations and 12 mm eye relief. The design was calculated with a 50 mm ROC VPH and 12 mm diameter, and 50 mm ROC polarization reflector and 18 mm diameter.

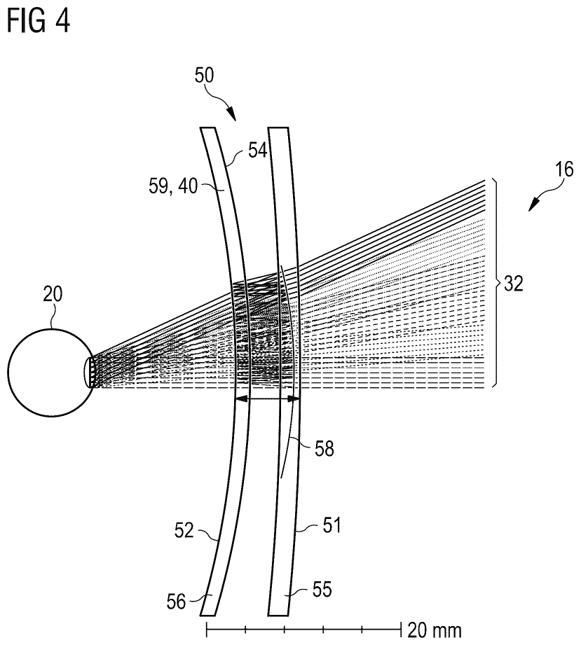

FIG. 4 shows another example embodiment of an optical lens for an augmented reality display. This example is closely related to the one of FIG. 3, i.e. the design is based on a curved hologram 40 and curved polarization reflector 54. However, different from FIG. 3, the design uses a flatter radius of curvature with higher index of refraction.

The first lens 55 is a base-2 lens and may have a thickness of about 2.0 mm, ROC 265 mm. The second lens 56 is a base-6 lens and may have a thickness of about 1.5 mm. TTL, in particular the distance between the lenses 55, 56, is set to 6.5 mm center thickness. Optical element calculations show that the design can be fine-tuned by adjusting radius of curvature and index of refraction.

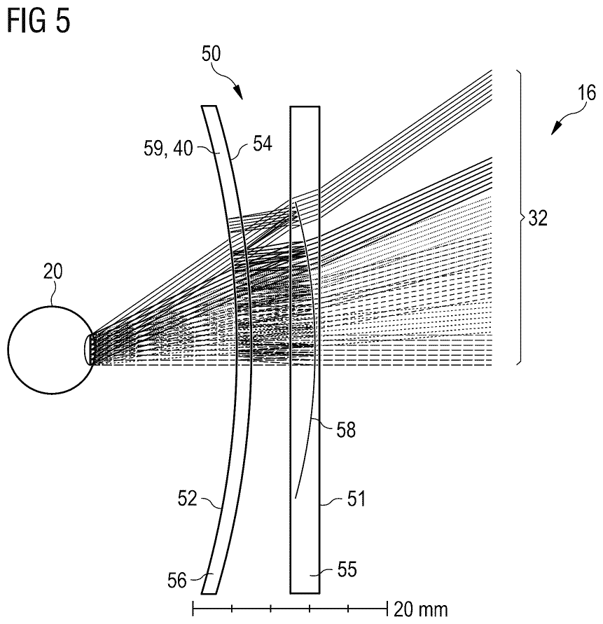

FIG. 5 shows another example embodiment of an optical lens for an augmented reality display. This design is also based on the previous ones. The first lens 55, however, is a flat lens, rather than a convex lens. In fact, the first lens 55 has two flat surfaces. This change with respect to the previous designs allows to achieve a yet larger field-of-view.

In this design the first lens 55 is 3 mm thick flat lens, with the dichroic reflector 58 buried inside. The second lens 56 is a 1.5 mm thick 88 mm ROC lens (base-6). TTL is set at 8.5 mm at center thickness.

The present application claims priority of the German application DE 102022126674.5, the disclosure content of which is incorporated herein by reference.

The designs discussed herein serve as examples to emphasize the improved optical performance that can be achieved. It is also apparent that various parameters have an impact on the overall performance. A person skilled in the art will readily understand that the optical combiner may comprise more lenses of various shape. The lenses can have a variety of curvatures or flat elements, which can be used as variable parameters for lens design. Furthermore, the dichroic reflector 58 may not necessarily be buried in a lens body but can be a separate optical element or a surface feature (e.g., coating) of a lens.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

1.-14. (canceled)

15. An optical lens comprising:
an optical spreader; and
an optical combiner having a first side and a second side opposite to the first side,
wherein the optical combiner is configured to transmit ambient light incident on the first side and to collimate image light incident on the second side,
wherein the optical spreader is configured to spread the collimated image light so as to form spread image light,
wherein the optical spreader comprises a hologram and the optical combiner comprises a polarizer, and
wherein the hologram and/or the polarizer have a curved profile.

16. The optical lens according to claim 15, wherein the curved profile is at least partially convex, concave, cylindrical, spherical or aspherical.

17. The optical lens according to claim 15, wherein the optical combiner is configured to transmit the ambient light essentially without aberration of the ambient light.

18. The optical lens according to claim 15, wherein a total refractive power of the optical lens, including the optical spreader and the optical combiner, is zero.

19. The optical lens according to claim 15, wherein the optical combiner comprises a reflective pancake optical combiner.

20. The optical lens according to claim 15, wherein the hologram comprises a Volume Phase Hologram.

21. The optical lens according to claim 15, further comprising:
at least one lens body,
wherein the hologram and/or the polarizer are buried inside the lens body and/or are arranged on a surface of the lens body.

22. The optical lens according to claim 21,
wherein the optical lens comprises a number of lenses,
wherein each lens comprises a respective lens body, and
wherein the lenses form a doublet, triplet, or multiplet, and/or a catadioptric system.

23. The optical lens according to claim 22,
wherein each optical lens comprises a first lens and a second lens forming the doublet,
wherein the first side of the optical combiner is, or is arranged on, a surface of the first lens,
wherein the second side of the optical combiner is, or is arranged on, a surface of the second lens, and
wherein the hologram and/or the polarizer are buried in the lens body of the second lens or are arranged on a surface of the lens body of the second lens.

24. The optical lens according to claim 15, wherein the polarizer comprises a polarization-dependent reflector.

25. The optical lens according to claim 15, wherein the optical combiner comprises a circular polarizer configured for circularly polarizing ambient light before the ambient light is incident on the first side of the optical combiner.

26. An optical system comprising:
the optical lens according to claim 15; and
an image generator configured to generate the image light,
wherein the optical lens is locatable in a field-of-view of a user of the optical system between the user and a scene,
wherein the ambient light from the scene is transmittable towards an eye of the user,
wherein the image light from the image generator is able to traverse the optical combiner several times and is able to exit the optical combiner towards the eye of the user as the collimated image light from the second side, whilst the ambient light is able to traverse the optical combiner only once.

27. The optical system according to claim 26, wherein the optical combiner is configured to reflect and control a divergence of the image light so that the image light is able to traverse the optical combiner four times and is able to exit the optical combiner as collimated light from the second side of the optical combiner, whilst the ambient light is able to traverse the optical combiner only once.

28. A wearable augmented reality display comprising:
the optical system of claim 26; and
a support frame configured for mounting the optical system on the user so that the optical lens is positioned in the field-of-view of the user.

29. The optical lens according to claim 15, wherein the optical combiner comprises an optically-powered reflector.

30. The optical lens according to claim 29, wherein the polarizer and the optically-powered reflector define an optical cavity.

31. The optical lens according to claim 29, wherein a retarder is located in the optical cavity.
